(19) United States
(12) Patent Application Publication
(10) Pub. No.: US 2026/0244066 A1
(43) Pub. Date: Aug. 20, 2026

(54) DISPLAY DEVICE

(71) Applicant: E Ink Holdings Inc., Hsinchu (TW)

(72) Inventors: Yi-Sheng Lin, Hsinchu (TW); Chia-Chun Yeh, Hsinchu (TW); Chen Chu Tsai, Hsinchu (TW)

(73) Assignee: E Ink Holdings Inc., Hsinchu (TW)

(21) Appl. No.: 19/383,737

(22) Filed: Nov. 9, 2025

(30) Foreign Application Priority Data
Feb. 17, 2025 (TW) 114105677

(51) Int. Cl. G02F 1/1685; G02F 1/167; G02F 1/16757; G02F 1/1676; G02F 1/1677

(52) U.S. Cl. CPC G02F 1/1685; G02F 1/167; G02F 1/16757; G02F 1/1676; G02F 1/1677

(57) ABSTRACT

A display device including a driving substrate and an electronic ink layer is provided. The electronic ink layer is disposed on the driving substrate and includes a package structure, an electronic ink material, a light source structure, and light shielding structures. The package structure includes an isolation component and a first package layer covering the isolation component. The isolation component surrounds encapsulation spaces, and the electronic ink material fills the encapsulation spaces to form display units. The light source structure is disposed on the first package layer and includes a first electrode structure, a second electrode, and light emitting units. The light emitting units are disposed between the first electrode structure and the second electrode structure and located between the first package layer and the light shielding patterns.

### CROSS-REFERENCE TO RELATED APPLICATION

This application claims the priority benefit of Taiwan application serial no. 114105677, filed on February 17, 2025. The entirety of the above-mentioned patent application is hereby incorporated by reference herein and made a part of this specification.

### BACKGROUND

### Technical Field

The disclosure relates to an electronic device, and particularly relates to a display device.

### Description of the Related Art

Electronic ink displays are reflective displays widely applied in various products. In low ambient light conditions, the screen brightness of these reflective displays may be insufficient for users to see clearly. To address this limitation, designs incorporating front light source modules have been proposed for these reflective displays. However, the addition of the light source modules inevitably increases the overall volume of the device and also limits applications in flexible designs.

### SUMMARY

The disclosure provides a display device with a built-in light source structure that can reduce the overall volume of the device.

According to an embodiment of the disclosure, a display device including a driving substrate and an electronic ink layer is provided. The electronic ink layer is disposed on the driving substrate and includes a package structure, an electronic ink material, a light source structure, and a plurality of light shielding patterns. The package structure includes an isolation component and a first package layer covering the isolation component. The isolation component surrounds a plurality of encapsulation spaces. The electronic ink material fills the encapsulation spaces to form a plurality of display units. The light source structure is disposed on the first package layer and includes a first electrode structure, a second electrode structure, and light emitting units. The light emitting units are disposed between the first electrode structure and the second electrode structure and located between the first package layer and the light shielding patterns.

In an embodiment of the disclosure, the light emitting units are respectively located above the display units.

In an embodiment of the disclosure, at least one of the first electrode structure and the second electrode structure continuously extends between the light emitting units and contacts the light emitting units.

In an embodiment of the disclosure, each of the light emitting units includes a first color emitting layer, a second color emitting layer, and a third color emitting layer stacked together.

In an embodiment of the disclosure, the second electrode structure includes a plurality of electrode circuits, and the electrode circuits contact different ones of the light emitting units.

In an embodiment of the disclosure, the electrode circuits are respectively disposed along the isolation component.

In an embodiment of the disclosure, the electrode circuits cross over above the display units.

In an embodiment of the disclosure, the light emitting units include a first light emitting unit, a second light emitting unit, and a third light emitting unit. The first light emitting unit, the second light emitting unit, and the third light emitting unit are dispersedly disposed.

In an embodiment of the disclosure, the second electrode structure includes a first electrode circuit, a second electrode circuit, and a third electrode circuit. The first electrode circuit contacts the first light emitting unit, the second electrode contacts the second light emitting unit, and the third electrode contacts the third light emitting unit.

In an embodiment of the disclosure, the first electrode circuit, the second electrode circuit, and the third electrode circuit are located at at least two conductive tiers.

In an embodiment of the disclosure, the first electrode structure is located at another conductive tier, and the another conductive tier is located between the at least two conductive tiers.

In an embodiment of the disclosure, the display device further includes a planarization layer disposed between the at least two conductive tiers.

In an embodiment of the disclosure, the light shielding patterns contact the second electrode structure.

In an embodiment of the disclosure, the isolation component has a tilted sidewall, and the tilted sidewall is tilted relative to the first package layer.

In an embodiment of the disclosure, a sidewall of the first electrode structure is tilted relative to the first package layer.

In an embodiment of the disclosure, the display device further includes a planarization layer. The planarization layer is disposed on the first package layer and laterally surrounds the first electrode structure.

In an embodiment of the disclosure, the first electrode structure includes a layered portion and a light guiding portion. The light guiding portion is disposed between the layered portion and the light emitting units, and a sidewall of the light guiding portion is tilted relative to the first package layer.

In an embodiment of the disclosure, the isolation component includes a microcup structure or a microcapsule structure.

In an embodiment of the disclosure, a material of the first electrode structure and the second electrode structure includes a transparent conductive material.

In light of the foregoing, the light source structure of the display device provided in one or more embodiments of the disclosure is directly disposed in the electronic ink layer, so as to optimize display effects and streamline the volume of the device.

In order to make the above-mentioned features and advantages of the disclosure comprehensible, embodiments accompanied with drawings are described in detail below.

### BRIEF DESCRIPTION OF THE DRAWINGS

The accompanying drawings, which are included to provide a further understanding of the disclosure, are incorporated in and constitute a part of this specification. The drawings illustrate embodiments of the disclosure and, together with the description, serve to explain the principles of the disclosure.

FIG. 1 is a schematic overall side view of a display device according to an embodiment of the disclosure.

FIG. 2 is a schematic partial cross-sectional view of an electronic ink layer according to an embodiment of the disclosure.

FIG. 3 is a schematic partial top view of an electronic ink layer according to an embodiment of the disclosure.

FIG. 4 is a schematic partial top view of an electronic ink layer according to an embodiment of the disclosure.

FIG. 5 to FIG. 6 are schematic views showing an arrangement relationship between a light source structure and an isolation component in an electronic ink layer in a top view direction according to different embodiments of the disclosure.

FIG. 7 is a schematic partial cross-sectional view of a light source structure according to an embodiment of the disclosure.

FIG. 8 to FIG. 9 are schematic views showing an arrangement relationship between a light source structure and an isolation component in an electronic ink layer in a top view direction according to several embodiments of the disclosure.

FIG. 10 is a schematic partial cross-sectional view of a light source structure according to an embodiment of the disclosure.

FIG. 11 is a schematic view showing an arrangement relationship between a light source structure and an isolation component in an electronic ink layer in a top view direction according to an embodiment of the disclosure.

FIG. 12 is a schematic partial cross-sectional view of a light source structure in an electronic ink layer according to an embodiment of the disclosure.

FIG. 13 is a schematic view showing an arrangement relationship between a light source structure and an isolation component in an electronic ink layer in a top view direction according to an embodiment of the disclosure.

FIG. 14 is a schematic partial cross-sectional view of a light source structure in an electronic ink layer according to an embodiment of the disclosure.

FIG. 15 is a schematic partial cross-sectional view of an electronic ink layer according to an embodiment of the disclosure.

FIG. 16 is a schematic partial cross-sectional view of an electronic ink layer according to an embodiment of the disclosure.

FIG. 17 is a schematic partial cross-sectional view of an electronic ink layer according to an embodiment of the disclosure.

FIG. 18 is a schematic partial cross-sectional view of an electronic ink layer according to an embodiment of the disclosure.

FIG. 19 is a schematic partial cross-sectional view of an electronic ink layer according to an embodiment of the disclosure.

FIG. 20 is a schematic partial cross-sectional view of an electronic ink layer according to an embodiment of the disclosure.

### DESCRIPTION OF THE EMBODIMENTS

Reference will now be made in detail to the exemplary embodiments of the disclosure, and examples of the exemplary embodiments are illustrated in the accompanying drawings. Whenever possible, the same reference numbers marking the corresponding elements/components/steps are used in the drawings and descriptions to indicate the same or similar parts.

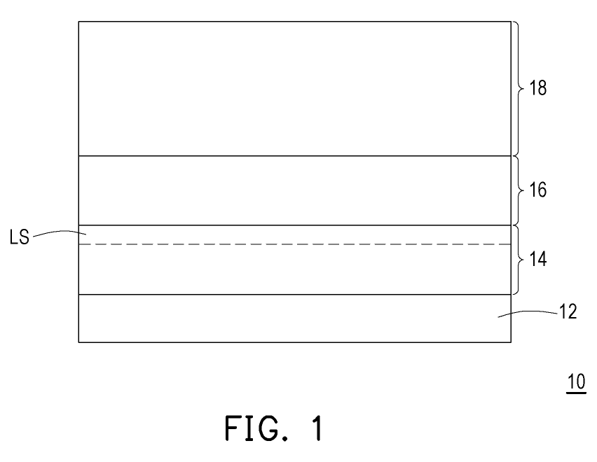

FIG. 1 is a schematic overall side view of a display device according to an embodiment of the disclosure. The display device 10 includes a driving substrate 12, an electronic ink layer 14, a touch layer 16, and a cover plate 18. The driving substrate 12 can include a carrier base material and driving circuit elements disposed on the carrier substrate and is configured to provide driving signals to the electronic ink layer 14 to perform a display function. The electronic ink layer 14 is disposed on the driving substrate 12. The touch layer 16 can be disposed on the electronic ink layer 14 through attachment to provide the display device 10 with a touch operation function. The cover plate 18 is attached to the touch layer 16 and located on an outer side of the display device 10 to provide protection and increase the strength of the device. In some embodiments, the touch layer 16 can be omitted, and the cover plate 18 can be directly attached to the electronic ink layer 14. In some embodiments, a bottom protection plate can be additionally attached to a side of the driving substrate 12 away from the electronic ink layer 14 to increase the mechanical strength of the display device 10.

The display device 10 is a reflective display device. Specifically, an electronic ink material in the electronic ink layer 14 is characterized by reflecting external light, and the electronic ink material can reflect the external light to a specified degree in a driving electric field provided by the driving substrate 12, thereby achieving a display effect. In this embodiment, the electronic ink layer 14 has a built-in light source structure LS, and the built-in light source structure LS can be located between the electronic ink material and the external environment. When the display device 10 displays an image, the light provided by the built-in light source structure LS can illuminate the electronic ink material for display use. Therefore, when the external light is dim, the display device 10 can utilize the light provided by the light source structure LS to maintain sufficient display brightness. In other words, the built-in light source structure LS aids in optimizing the display effect of the display device 10. Moreover, the built-in light source structure LS is directly built into the electronic ink layer 14 rather than being disposed on the electronic ink layer 14 through attachment or other methods. Therefore, the built-in light source structure LS contributes to streamlining the volume of the display device 10, which improves the application flexibility of the display device 10.

For the convenience of explanation, the following content and the accompanying drawings will describe various embodiments of the electronic ink layer with the built-in light source structure without explaining other components in the display device in details. It is apparent that the electronic ink layer in the following individual embodiments can serve as possible implementations of the electronic ink layer 14 in FIG. 1, which should however not be construed as a limitation in the disclosure.

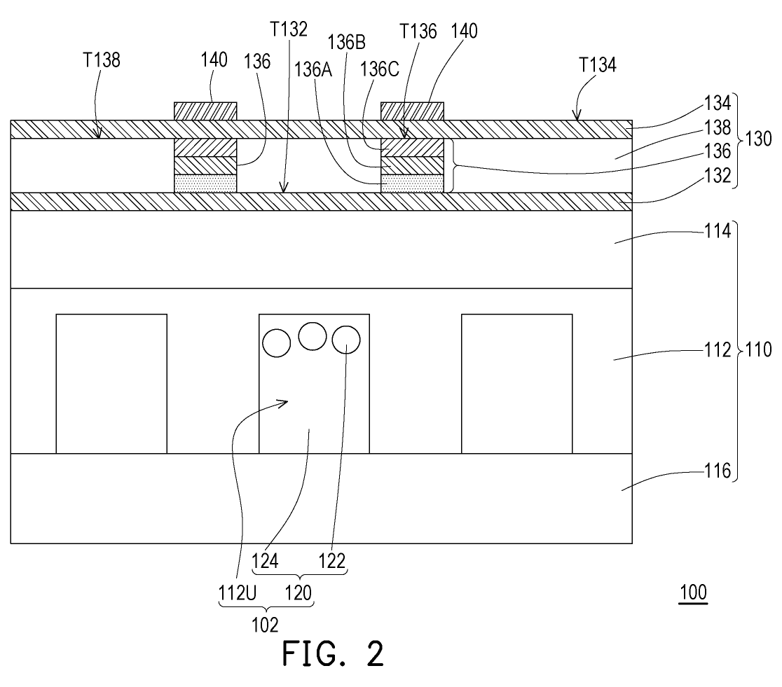

FIG. 2 is a schematic partial cross-sectional view of an electronic ink layer according to an embodiment of the disclosure. The electronic ink layer 100 includes a package structure 110, an electronic ink material 120, a light source structure 130, and a plurality of light shielding patterns 140. The package structure 110 includes an isolation component 112, a first package layer 114, and a second package layer 116. The first package layer 114 covers the isolation component 112. The isolation component 112 surrounds a plurality of encapsulation spaces 112U, and the electronic ink material 120 fills the encapsulation spaces 112U to form a plurality of display units 102. The second package layer 116 and the first package layer 114 are located on opposite sides of the isolation component 112 to enclose the display units 102 between them. The light source structure 130 is disposed on the first package layer 114. The light shielding patterns 140 are disposed on a side of the light source structure 130 away from the display units 102. Here, the isolation component 112 is, for instance, a microcup structure, and individual display units 102 can be constituted by the electronic ink material 120 in the individual encapsulation spaces 112U.

The electronic ink material 120 includes display particles 122 and a matrix 124 for dispersing the display particles 122. In some embodiments, at least some of the display particles 122 have light reflecting properties, and the display particles 122 can migrate in the matrix 124 while the display particles 122 are driven by an electric field to present different distribution states. Thus, the display particles 122 in different distribution states can provide different degrees of light reflection to display images. In some embodiments, the display particles 122 can include color display particles suitable for reflecting different colors.

The light source structure 130 is a structure directly formed on the first package layer 114 and built into the electronic ink layer 100. In other words, the light source structure 130 is not disposed on the first package layer 114 through any bonding method, such as attachment, fastening, and so on. In some embodiments, the light source structure 130 can be formed on the first package layer 114 through printing, coating, or similar alternative methods. Therefore, the electronic ink layer 100 integrated with the light source structure 130 can realize a design of providing its own light source without significantly increasing its volume.

Specifically, the light source structure 130 includes a first electrode structure 132, a second electrode structure 134, a plurality of light emitting units 136, and a planarization layer 138. The light emitting units 136 are disposed between the first electrode structure 132 and the second electrode structure 134 and located between the first package layer 114 and the light shielding patterns 140. The planarization layer 138 is disposed between the first electrode structure 132 and the second electrode structure 134 and laterally contacts the light emitting units 136. The planarization layer 138 and the light emitting units 136 can be both disposed on a top surface T132 of the first electrode structure 132, and a top surface T138 of the planarization layer 138 can be coplanar with top surfaces T136 of the light emitting units 136. As such, the second electrode structure 134 can be formed on the common plane of the top surface T138 of the planarization layer 138 and the top surfaces T136 of the light emitting units 136.

The first electrode structure 132, the second electrode structure 134, the light emitting units 136, the planarization layer 138, and the light shielding patterns 140 can be formed on a surface of the first package layer 114 in the form of the required layout by printing or coating the corresponding materials. In FIG. 2, both the first electrode structure 132 and the second electrode structure 134 are structures that continuously extend between the light emitting units 136 and contact the light emitting units 136, and these structures can be planar layered structures, which should however not be construed as a limitation in the disclosure. In some embodiments, at least one of the first electrode structure 132 and the second electrode structure 134 can be a strip-like structure in the top view. A material of the first electrode structure 132 and the second electrode structure 134 can include a transparent conductive material, which can allow the light emitted by the light emitting units 136 to pass through.

A material of the light emitting units 136 can be an organic light emitting material, and the material can be a light emitting material that can be formed on the first electrode structure 132 through printing. In some embodiments, the light emitting units 136 can include a first color emitting layer 136A, a second color emitting layer 136B, and a third color emitting layer 136C stacked together. The light emitted by the first color emitting layer 136A, the second color emitting layer 136B, and the third color emitting layer 136C includes red light, green light, and blue light. In other words, the light emitting units 136 are composed of a stacked structure of a red light emitting layer, a green light emitting layer, and a blue light emitting layer. The order of stacking the red light emitting layer, the green light emitting layer, and the blue light emitting layer of the light emitting units 136 can be adjusted according to different requirements and is not limited to a specific order. Additionally, the thicknesses of the red light emitting layer, the green light emitting layer, and the blue light emitting layer in the light emitting units 136 can also be adjusted based on the characteristics of the light emitting materials, the desired light emitting effect, and other factors. In other embodiments, the light emitting units 136 can be formed by stacking two light emitting layers or by combining one or multiple light emitting layers with a light conversion material (such as quantum dots). The light emitting units 136 as a whole can serve to emit white light, which should not be construed as a limitation in the disclosure. In some embodiments, different light emitting units 136 can emit light of different colors.

The electronic ink layer 100 achieves display through adopting a reflective display technology. Therefore, only the portion of light that travels towards the display unit 102 from the light source structure 130 can be effectively used as display light. The portion of light that travels away from the display unit 102 from the light source structure 130 may affect the viewing quality for users, e.g., causing glare. Thus, light shielding patterns 140 are disposed above the individual light emitting units 136 to block light that directly radiates outward. The light shielding patterns 140 can directly contact a top surface T134 of the second electrode structure 134 and are overlapped with the area occupied by the light emitting units 136.

The placement of the light emitting units 136 can be adjusted according to different requirements, and FIG. 2 illustrates the light emitting units 136 positioned above the isolation component 112. Generally, the area occupied by the display units 102 is the actual displayable screen area, while the area occupied by the isolation component 112 is originally not for displaying images. With the light emitting units 136 located above the isolation component 112, the light shielding patterns 140 are also positioned above the isolation component 112 and do not block the display area, which contributes to maintaining the size of the display area.

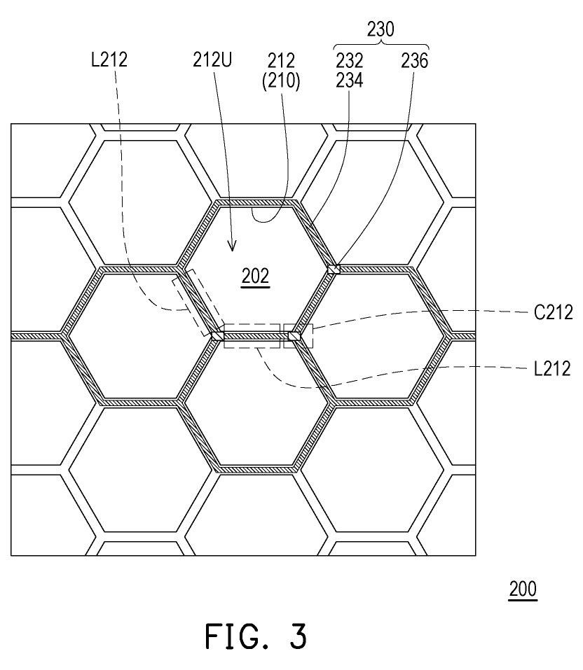

FIG. 3 is a schematic partial top view of an electronic ink layer according to an embodiment of the disclosure. An electronic ink layer 200 in FIG. 3 can be applied to the display device 10 in FIG. 1 as an embodiment of the electronic ink layer 14. Additionally, the structure presented in FIG. 3 can also serve as an embodiment of the electronic ink layer 100 in FIG. 2 from a top view perspective. For ease of explanation, FIG. 3 shows that the electronic ink layer 200 includes display units 202, package structures 210 (only isolation components 212 are drawn), and light source structures 230, whereas the electronic ink layer 200 can further include other structures omitted in FIG. 3, such as the first package layer 114, the second package layer 116, and the light shielding patterns 140 as shown in FIG. 2. Besides, the display units 202 can correspond to the display units 102 in FIG. 2 as an embodiment of the disclosure in a top view perspective, the isolation components 212 can correspond to the isolation component 112 in FIG. 2 as an embodiment of the disclosure in a top view perspective, and the light source structures 230 can correspond to the light source structure 130 in FIG. 2 as an embodiment of the disclosure in a top view perspective.

In FIG. 3, the isolation components 212 have a plurality of linear sections L212 extending in different directions in the top view, and these linear sections L212 intersect with each other. For instance, these linear sections L212 can enclose hexagonal areas to form encapsulation spaces 212U and have honeycomb-like patterns. These encapsulation spaces 212U are arranged adjacently to define the display units 202. In other embodiments, the linear sections L212 can extend simply in two directions to enclose a plurality of quadrilateral areas. Alternatively, the linear sections L212 can extend in three or more directions to enclose areas of various geometric shapes.

Each light source structure 230 includes a first electrode structure 232, a second electrode structure 234, and a plurality of light emitting units 236. The first electrode structure 232 and the second electrode structure 234 can be disposed along the isolation component 212 and extend continuously between the light emitting units 236. It can be learned from the cross-sectional structure design shown in FIG. 2 that the first electrode structure 232 and the second electrode structure 234 are located at different tiers but can overlap each other in the top view. Therefore, the first electrode structure 232 and the second electrode structure 234 are marked in the same pattern in FIG. 3. In the top view, the light emitting units 236 are all located above the isolation component 212 and can contact the first electrode structure 232 and the second electrode structure 234. The light emitting units 236 can be located at intersection points C212 where the linear sections L212 of the isolation component 212 intersect, which should however not be construed as a limitation in the disclosure. In some embodiments, the light emitting units 236 can be located on the linear sections L212 of the isolation component 212. Additionally, the distribution density of the light emitting units 236 can be adjusted according to different designs.

Although the light emitting units 236 are disposed between the first electrode structure 232 and the second electrode structure 234 in the cross-sectional structure, as the light emitting units 136 shown in FIG. 2, for ease of explanation, the light emitting units 236 are directly drawn in FIG. 3. Besides, the light emitting units 236 can be implemented in the form of a plurality of light emitting layers or a light emitting layer combined with light conversion materials, which is similar to the light emitting units 136 in FIG. 2. The light emitting units 236 are, for instance, organic light-emitting diodes, and individual light emitting layers can be formed through printing. The light emitting units 236 can emit white light under the driving current provided by the first electrode structure 232 and the second electrode structure 234, and the white light can be utilized by the display units 202. In this embodiment, the area occupied by the isolation component 212 is originally designed as an area that does not provide display function. The light source structures 230 disposed along the isolation component 212 do not block the display units 202. Therefore, a material of the light source structures 230 is not required to be limited to a transparent material. In other words, the first electrode structure 232, the second electrode structure 234, and the light emitting units 236 can be made of either a transparent material or an opaque material.

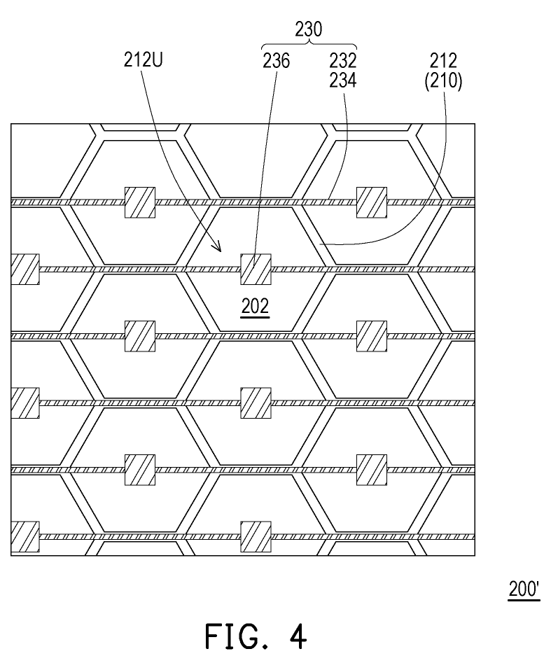

In other embodiments, as shown by an electronic ink layer 200' in FIG. 4, the light emitting units 236 of the light source structures 230 are arranged to overlap the display units 202. The electronic ink layer 200' includes the display units 202, the package structures 210 (only the isolation components 212 are drawn), and the light source structure 230. In this embodiment, the first electrode structures 232 and the second electrode structures 234 can each include a plurality of electrode circuits, and individual electrode circuits can contact several light emitting units 236. The light emitting units 236 are located above the encapsulation spaces 212U surrounded by the isolation components 212 and overlap the display units 202. In other words, the light emitting units 236 are located within the display area of the display units 202. The electrode circuits of the first electrode structures 232 and the second electrode structures 234 cross over the display units 202. A material of the light emitting units 236 and the electrode circuits of the first electrode structures 232 and the second electrode structures 234 can be a transparent material to reduce the degree to which the light source structures 230 block display light. However, since the light source structures 230 can provide light for display and contribute to enhancement of display brightness, when the light source structures 230 are arranged to overlap the display units 202, the light source structures 230 can be made of other materials in addition to the transparent material.

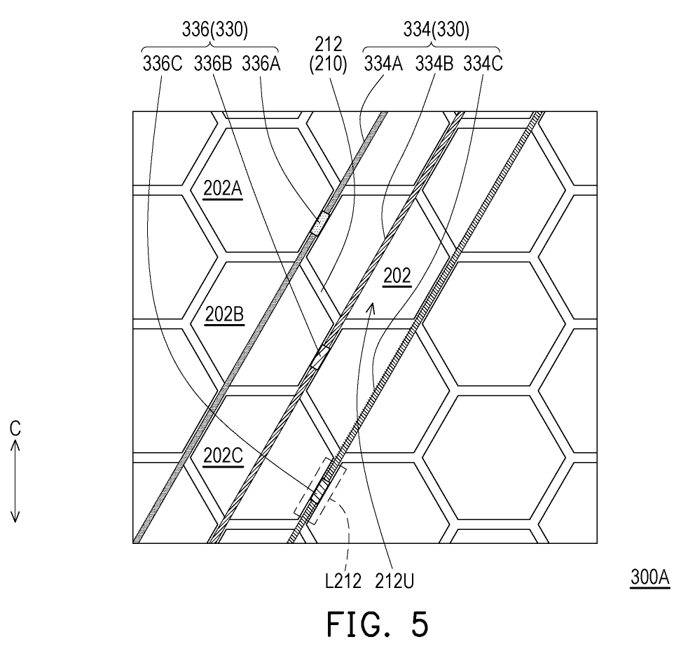

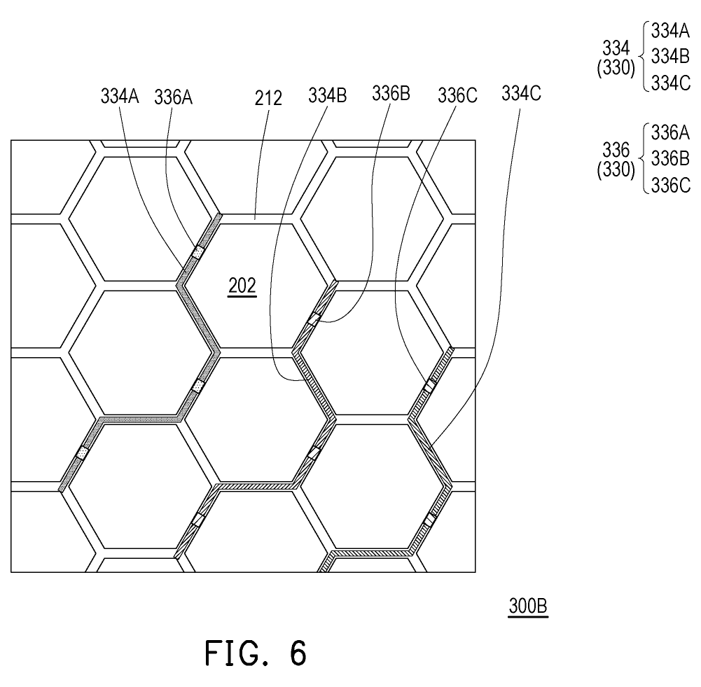

FIG. 5 to FIG. 6 are schematic views showing an arrangement relationship between a light source structure and an isolation component in an electronic ink layer in a top view direction according to different embodiments of the disclosure. An electronic ink layer 300A in FIG. 5 includes package structures 210, an electronic ink material, light source structures 330, and a plurality of light shielding patterns. For ease of explanation, FIG. 5 mainly shows the isolation components 212 of the package structures 210, the second electrode structures 334, and the light emitting units 336 of the light source structures 330, while other components are omitted. In some embodiments, the electronic ink layer 300A can further include the electronic ink material 120 and the light shielding patterns 140 shown in FIG. 2, and the package structures 210 can also include the first package layers 114 and the second package layers 116 shown in FIG. 2. Additionally, the first electrode structures in the light source structures 330 can be implemented in the form of a full-surface electrode layer and thus are not shown in FIG. 5, which should not be construed as a limitation in the disclosure. Specifically, FIG. 5 mainly serves to explain the arrangement relationship among the isolation components 212, the second electrode structures 334, and the light emitting units 336, while the electronic ink layer 300A is not limited to simply include these components.

In this embodiment, the layout design of the isolation components 212 can be referred to as that explained above with reference to FIG. 3. Each light emitting unit 336 can include, for instance, a first light emitting unit 336A, a second light emitting unit 336B, and a third light emitting unit 336C. The first light emitting unit 336A, the second light emitting unit 336B, and the third light emitting unit 336C are disposed with intervals between one another and provide light of different colors. The individual color light emitted by the first light emitting unit 336A, the second light emitting unit 336B, and the third light emitting unit 336C can be mixed to generate white light, for instance. In FIG. 5, the first light emitting units 336A, the second light emitting units 336B, and the third light emitting units 336C can be dispersedly disposed along the linear sections L212 of the isolation components 212. The first light emitting units 336A, the second light emitting units 336B, and the third light emitting units 336C can be dispersedly disposed, for instance, at the lower right side of three display units 202A to 202C arranged along the same column direction C, which should however not be construed as a limitation in the disclosure.

Each second electrode structure 334 can include a plurality of independent electrode circuits, such as a first electrode circuit 334A, a second electrode circuit 334B, and a third electrode circuit 334C. The first electrode circuit 334A can contact and be electrically connected to the first light emitting unit 336A, the second electrode circuit 334B can contact and be electrically connected to the second light emitting unit 336B, and the third electrode circuit 334C can contact and be electrically connected to the third light emitting unit 336C. The first electrode circuit 334A, the second electrode circuit 334B, and the third electrode circuit 334C can be independent from one another to drive the light emitting units 336 of different colors, respectively. As shown in FIG. 5, each of the first electrode circuit 334A, the second electrode circuit 334B, and the third electrode circuit 334C can extend along one of the linear sections L212 of the isolation component 212. The first electrode circuit 334A, the second electrode circuit 334B, and the third electrode circuit 334C can be parallel to one another. The first electrode circuit 334A, the second electrode circuit 334B, and the third electrode circuit 334C can cross over the display units 202, which should however not be construed as a limitation in the disclosure.

The electronic ink layer 300B in FIG. 6 is similar to the electronic ink layer 300A in FIG. 5, and the arrangement relationship of the isolation components 212, the second electrode structures 334, and the light emitting units 336 is shown. The light emitting units 336 include the first light emitting units 336A, the second light emitting units 336B, and the third light emitting units 336C. Each of the first light emitting units 336A and one of the second light emitting units 336B are disposed on opposite sides of a corresponding display unit 202, and each of the second light emitting units 336B and one of the third light emitting units 336C are disposed on opposite sides of another corresponding display unit 202.

In addition, each second electrode structure 334 includes the first electrode circuit 334A, the second electrode circuit 334B, and the third electrode circuit 334C. In this embodiment, the first electrode circuits 334A, the second electrode circuits 334B, and the third electrode circuits 334C are substantially completely disposed along the isolation components 212. Therefore, none of the first electrode circuits 334A, the second electrode circuits 334B, and the third electrode circuits 334C cross over the display units 202. Moreover, the first electrode circuits 334A, the second electrode circuits 334B, and the third electrode circuits 334C are arranged side by side without intersecting or overlapping.

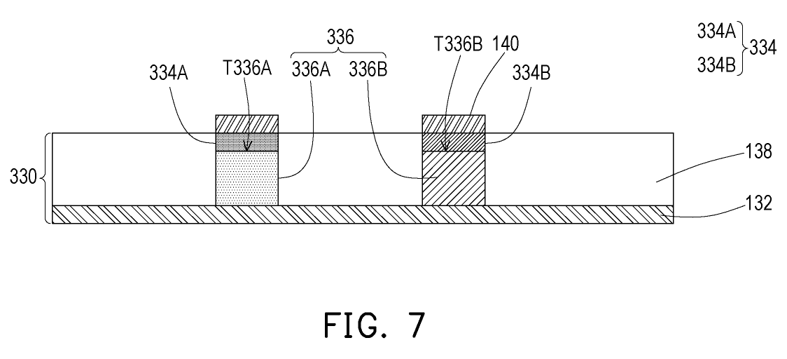

FIG. 7 is a schematic partial cross-sectional view of a light source structure according to an embodiment of the disclosure. The light source structure 330 in FIG. 7 can be applied to the display device 10 in FIG. 1 as an embodiment of the built-in light source structure LS in the electronic ink layer 14. Additionally, the structure shown in FIG. 7 can also serve as an embodiment of the light source structure 130 in the electronic ink layer 100 depicted in FIG. 2 and the light source structure 330 depicted in FIG. 5 and FIG. 6. As shown in FIG. 7, the light source structure 330 includes a first electrode structure 132, a second electrode structure 334, a plurality of light emitting units 336, and a planarization layer 138, where the structure and the arrangement of the first electrode structure 132 and the planarization layer 138 can be referred to as those described above with reference to FIG. 2, and the layout of the second electrode structure 334 in the top view can be referred to as the layout of the second electrode structure 334 in FIG. 5 and FIG. 6. Moreover, FIG. 7 further shows the arrangement of the light shielding patterns 140; for instance, the light shielding patterns 140 are disposed on the light source structure 330 and located above individual light emitting units 336.

For ease of explanation, FIG. 7 simply shows the first electrode circuit 334A and the second electrode circuit 334B of the second electrode structure 334 and simply shows the first light emitting unit 336A and the second light emitting unit 336B of the light emitting units 336. Specifically, the first light emitting unit 336A and the second light emitting unit 336B emit light of different colors, and the layout design of the first light emitting unit 336A and the second light emitting unit 336B in the top view can be implemented in the manner depicted in FIG. 5 or FIG. 6, which should however not be construed as a limitation in the disclosure. Moreover, although the cross-sectional structure in FIG. 7 does not show the third light emitting unit 336C and the third electrode circuit 334C depicted in FIG. 5 and FIG. 6, the third light emitting unit 336C and the third electrode circuit 334C can be implemented in the same design manner.

In FIG. 7, the first electrode structure 132 extends continuously over the first light emitting unit 336A and the second light emitting unit 336B and contacts the first light emitting unit 336A and the second light emitting unit 336B. The planarization layer 138 is sandwiched between the first electrode structure 132 and the second electrode structure 334. Specifically, the planarization layer 138 and the first light emitting unit 336A are both disposed on the first electrode structure 132, and the thickness of the planarization layer 138 is designed to expose a top surface T336A of the first light emitting unit 336A and a top surface T336B of the second light emitting unit 336B. The first electrode circuit 334A and the second electrode circuit 334B can contact the top surface T336A of the first light emitting unit 336A and the top surface T336B of the second light emitting unit 336B. As such, the first electrode circuit 334A and the second electrode circuit 334B are in the same conductive tier in FIG. 7 but are independently arranged in parallel in FIG. 5 and FIG. 6, thereby allowing the first electrode circuit 334A and the second electrode circuit 334B to provide different driving currents for the first light emitting unit 336A and the second light emitting unit 336B. Therefore, the light emission intensity of the first light emitting unit 336A and the second light emitting unit 336B can be independently controlled to meet the requirement of adjusting color temperature.

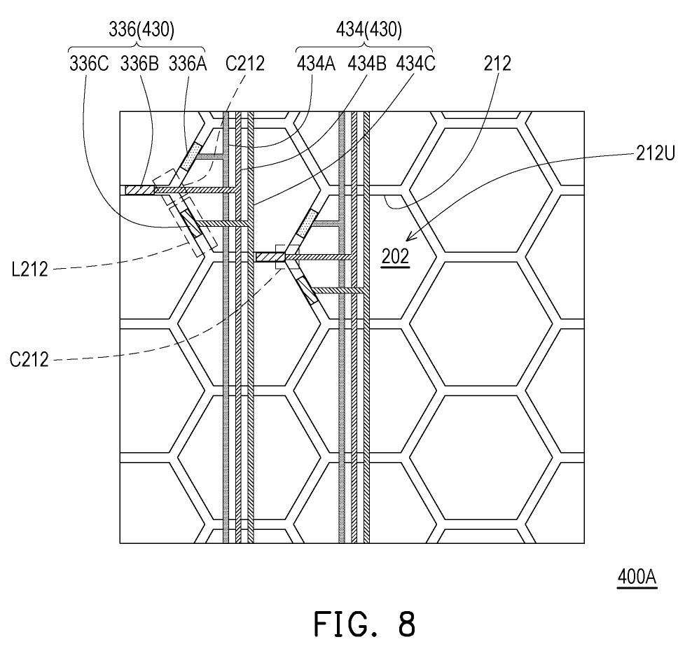

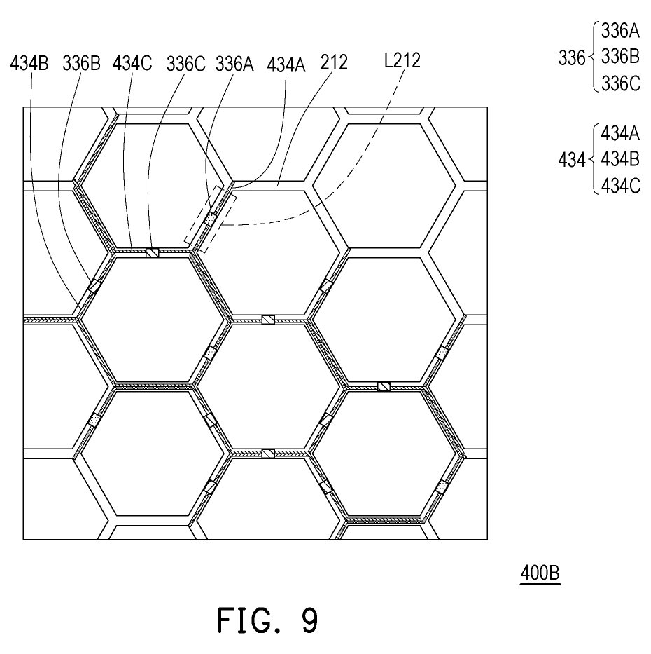

FIG. 8 to FIG. 9 are schematic views showing an arrangement relationship between a light source structure and an isolation component in an electronic ink layer in a top view direction according to several embodiments of the disclosure. An electronic ink layer 400A in FIG. 8 includes the package structures 210, an electronic ink material, light source structures 430, and a plurality of light shielding patterns. For ease of explanation, FIG. 8 mainly shows the isolation components 212 of the package structures 210 and the second electrode structures 434 and the light emitting units 336 of the light source structures 430, while other components are omitted. In some embodiments, the electronic ink layer 400A can further include the electronic ink material 120 and the light shielding patterns 140 shown in FIG. 2, and each package structure 210 can further include the first package layer 114 and the second package layer 116 shown in FIG. 2. Therefore, FIG. 8 mainly serves to explain the arrangement relationship among the isolation components 212, the second electrode structures 434, and the light emitting units 336, while the electronic ink layer 400A is not limited to simply include these components.

FIG. 8 shows the arrangement relationship among the isolation components 212, the second electrode structures 434, and the light emitting units 336 in the electronic ink layer 400A. Each light emitting unit 336 includes a first light emitting unit 336A, a second light emitting unit 336B, and a third light emitting unit 336C, and the first light emitting units 336A, the second light emitting units 336B, and the third light emitting units 336C are dispersedly disposed on the linear sections L212 of the isolation components 212. One of the first light emitting units 336A, one of the second light emitting units 336B, and one of the third light emitting units 336C are, for instance, concentrated near one of the intersection points C212 of the linear sections L212. The adjacent arrangement of the first light emitting units 336A, the second light emitting units 336B, and the third light emitting units 336C aids in enhancing the color mixing effect of different color light.

In FIG. 8, each second electrode structure 434 includes a first electrode circuit 434A, a second electrode circuit 434B, and a third electrode circuit 434C, and the first electrode circuit 434A, the second electrode circuit 434B, and the third electrode circuit 434C are respectively in contact with and electrically connected to the first light emitting unit 336A, the second light emitting unit 336B, and the third light emitting unit 336C. The first electrode circuit 434A, the second electrode circuit 434B, and the third electrode circuit 434C can be parallel to one another and extend substantially along the column direction C. As such, the first electrode circuits 434A, the second electrode circuits 434B, and the third electrode circuits 434C can extend across the tops of the light emitting units 336, which should however not be construed as a limitation in the disclosure. Additionally, the first electrode circuits 434A, the second electrode circuits 434B, and the third electrode circuits 434C can intersect with one another.

An electronic ink layer 400B in FIG. 9 is similar to the electronic ink layer 400A in FIG. 8 and shows the arrangement relationship among the isolation components 212, the second electrode structures 434, and the light emitting units 336. Each light emitting unit 336 includes a first light emitting unit 336A, a second light emitting unit 336B, and a third light emitting unit 336C. The first light emitting units 336A, the second light emitting units 336B, and the third light emitting units 336C are dispersedly disposed on the linear sections L212 of the isolation components 212. Each second electrode structure 434 includes a first electrode circuit 434A, a second electrode circuit 434B, and a third electrode circuit 434C, and the first electrode circuits 434A, the second electrode circuits 434B, and the third electrode circuits 434C are disposed along the isolation components 212.

In this embodiment, one of the second light emitting units 336B and one of the third light emitting units 336C are disposed on the linear section L212 adjacent to one of the first light emitting units 336A, such that the first light emitting unit 336A, the second light emitting unit 336B, and the third light emitting unit 336C are disposed in close proximity to one another, which aids in enhancing the color mixing effect of different color light. Additionally, none of the first electrode circuits 434A, the second electrode circuits 434B, and the third electrode circuits 434C cross over the display units 202, and the first electrode circuits 434A, the second electrode circuits 434B, and the third electrode circuits 434C can partially overlap along the linear sections L212.

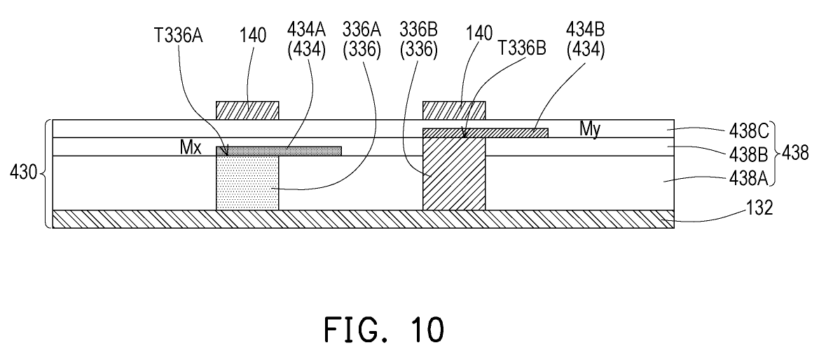

FIG. 10 is a schematic partial cross-sectional view of a light source structure according to an embodiment of the disclosure. The light source structure 430 in FIG. 10 can be applied to the display device 10 in FIG. 1 as an embodiment of the built-in light source structure LS in the electronic ink layer 14. Additionally, the structure shown in FIG. 10 can serve as an embodiment of the cross-sectional structure of the light source structure 430 in FIG. 8 and FIG. 9. For ease of explanation, FIG. 10 mainly shows the relationship between two of the light emitting units 336 (the first light emitting unit 336A and the second light emitting unit 336B) and other components explained in the embodiments depicted in FIG. 8 and FIG. 9.

Specifically, the light source structure 430 includes a first electrode structure 132, a second electrode structure 434, a plurality of light emitting units 336, and a planarization layer 438, where the first electrode structure 132 can be referred to as that described above with reference to FIG. 2. Both the first light emitting unit 336A and the second light emitting unit 336B are disposed on the first electrode structure 132, and the first light emitting unit 336A and the second light emitting unit 336B serve to emit light of different colors. The first electrode structure 132, for instance, continuously extends between the first light emitting unit 336A and the second light emitting unit 336B and contacts the first light emitting unit 336A and the second light emitting unit 336B.

The second electrode structure 434 includes a plurality of electrode circuits, and these electrode circuits contact different ones of the light emitting units 336. For instance, FIG. 10 shows that the second electrode structure 434 includes the first electrode circuit 434A contacting the first light emitting unit 336A and the second electrode circuit 434B contacting the second light emitting unit 336B. The first electrode circuit 434A and the second electrode circuit 434B are independent of each other, thus allowing the first light emitting unit 336A and the second light emitting unit 336B to emit light under different driving currents and enabling the adjustment of the emitted color temperature. As shown in FIG. 10, the first electrode circuit 434A and the second electrode circuit 434B are located in different conductive tiers Mx and My, and the planarization layer 438 can include a plurality of layers to isolate the different conductive tiers Mx and My. As such, the second electrode circuit 434A and the second electrode circuit 434B can intersect or overlap in the top view direction, but the second electrode circuit 434A and the second electrode circuit 434B do not contact each other and thus provide independent electrical transmission paths.

The planarization layer 438 can include a first planarization layer 438A, a second planarization layer 438B, and a third planarization layer 438C. The first planarization layer 438A laterally surrounds a portion of the first light emitting unit 336A and the second light emitting unit 336B. The first electrode circuit 434A constituted by the conductive tier Mx can be disposed on the first planarization layer 438A. The second planarization layer 438B laterally surrounds the second light emitting unit 336B. The second electrode circuit 434B constituted by the conductive tier My can be disposed on the second planarization layer 438B. The third planarization layer 438C covers the second electrode circuit 434B constituted by the conductive tier My. The thickness of the first planarization layer 438A can be set to expose the top surface T336A of the first light emitting unit 336A, allowing the first electrode circuit 434A to contact the first light emitting unit 336A. Similarly, the thickness of the second planarization layer 438B can be set to expose the top surface T336B of the second light emitting unit 336B, allowing the second electrode circuit 434B to contact the second light emitting unit 336B. Moreover, the thickness of the third planarization layer 438C can cover the second electrode circuit 434B, which should however not be construed as a limitation in the disclosure. In some embodiments, the light source structure 430 can further include the third light emitting unit 336C mentioned in FIG. 8 and FIG. 9, and the second electrode structure 434 can further include the third electrode circuit 434C corresponding to the third light emitting unit 336C, where the third electrode circuit 434C can be located in other conductive tiers, and the planarization layer 438 can include additional planarization layers.

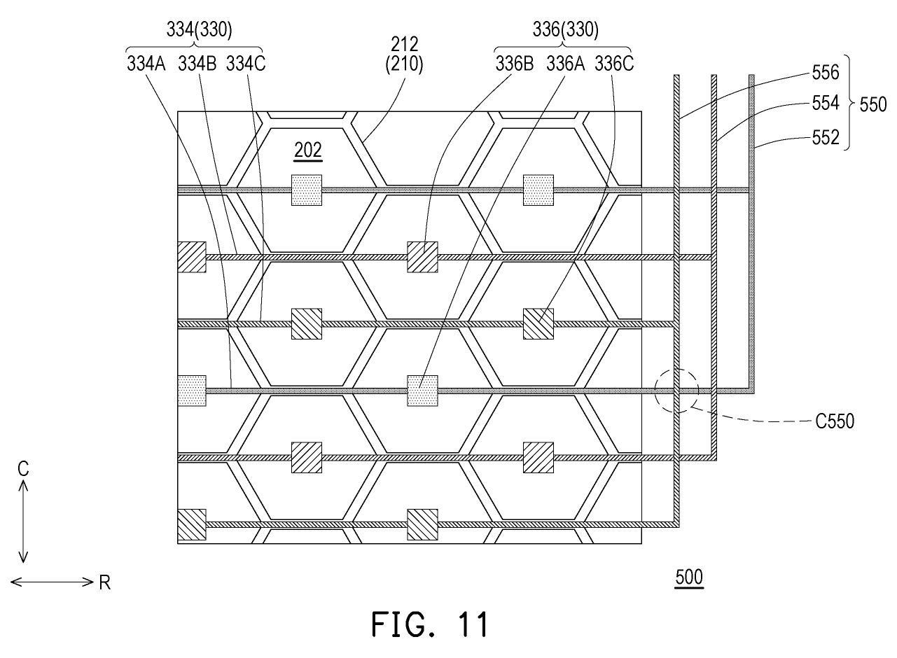

FIG. 11 is a schematic view showing an arrangement relationship between a light source structure and an isolation component in an electronic ink layer in a top view direction according to an embodiment of the disclosure. An electronic ink layer 500 in FIG. 11 includes package structures 210, an electronic ink material, light source structures 330, and a plurality of light shielding patterns. For ease of explanation, FIG. 11 mainly shows the isolation components 212 of the package structures 210, the second electrode structures 334, and the light emitting units 336 of the light source structures 330, while other components are omitted. Additionally, FIG. 11 further shows a portion of peripheral circuits 550 of the light source structures 330, and the peripheral circuits 550 can be connected to the second electrode structures 334. In some embodiments, the electronic ink layer 500 can further include the electronic ink material 120 and the light shielding patterns 140 shown in FIG. 2, and the package structures 210 can further include the first package layer 114 and the second package layer 116 shown in FIG. 2. Therefore, FIG. 11 mainly serves to explain the arrangement relationship among the isolation components 212, the second electrode structures 334, and the light emitting units 336, while the electronic ink layer 500 is not limited to simply include these components.

In this embodiment, the layout design of the isolation components 212 is the same as that described in the embodiment as shown in FIG. 3, and the isolation components 212 can define the display units 202. The light emitting units 336 include the first light emitting units 336A, the second light emitting units 336B, and the third light emitting units 336C. The first light emitting units 336A, the second light emitting units 336B, and the third light emitting units 336C are each disposed within the display area of the display units 202. The first light emitting units 336A are arranged in a row along a row direction R, the second light emitting units 336B are arranged in a row along the row direction R, and the third light emitting units 336C are arranged in a row along the row direction R. The first light emitting units 336A, the second light emitting units 336B, and the third light emitting units 336C are located in different rows. Each second electrode structure 334 includes the first electrode circuit 334A, the second electrode circuit 334B, and the third electrode circuit 334C. The first electrode circuits 334A, the second electrode circuits 334B, and the third electrode circuits 334C each extend along the row direction R and cross over the display units 202. The first electrode circuits 334A, the second electrode circuits 334B, and the third electrode circuits 334C extend in different rows.

Each peripheral circuit 550 can include a first signal line 552, a second signal line 554, and a third signal line 556. The first signal line 552 is connected to the first electrode circuit 334A, the second signal line 554 is connected to the second electrode circuit 334B, and the third signal line 556 is connected to the third electrode circuit 334C. The first signal lines 552, the second signal lines 554, and the third signal lines 556 each extend along the column direction C to connect the corresponding electrode circuits together. Therefore, the first signal lines 552, the second signal lines 554, and the third signal lines 556 intersect with the first electrode circuits 334A, the second electrode circuits 334B, and the third electrode circuits 334C.

In this embodiment, the light source structures 330 can utilize the method described in the embodiment above with reference to FIG. 7 to implement the cross-sectional design of individual components. As such, the first electrode circuits 334A, the second electrode circuits 334B, and the third electrode circuits 334C are circuit structures arranged side by side in the same tier. Therefore, the intersection points C550 where the first signal lines 552, the second signal lines 554, and the third signal lines 556 intersect with the first electrode circuits 334A, the second electrode circuits 334B, and the third electrode circuits 334C can adopt a multi-conductive layer structure to avoid short circuits among these circuits.

In some alternative embodiments, the second electrode circuits 334 can adopt the cross-sectional design of the second electrode circuits 434 described in FIG. 10. As such, the first electrode circuits 334A, the second electrode circuits 334B, and the third electrode circuits 334C can be implemented in the same manner as the first electrode circuits 434A, the second electrode circuits 434B, and the third electrode circuits 434C in FIG. 10, respectively and can be located in different conductive tiers. At the same time, the first signal lines 552, the second signal lines 554, and the third signal lines 556 can also be located in different conductive tiers. Therefore, although the first signal lines 552, the second signal lines 554, and the third signal lines 556 intersect with the first electrode circuits 334A, the second electrode circuits 334B, and the third electrode circuits 334C, they do not contact one another and remain electrically independent.

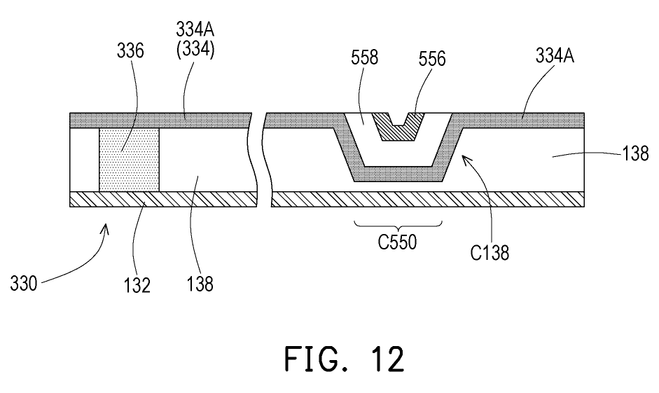

FIG. 12 is a schematic partial cross-sectional view of a light source structure in an electronic ink layer according to an embodiment of the disclosure. The cross-sectional structure in FIG. 12 serves to explain one implementation manner of the light source structures 330 and the peripheral circuits 550 in FIG. 11, which should however not be construed as a limitation in the disclosure. Specifically, the cross-sectional structure in FIG. 12 mainly shows a possible implementation manner of the corresponding peripheral circuit 550 when the cross-sectional structure of the light source structure 330 is implemented in the manner shown in FIG. 7. Therefore, the explanation above with reference to FIG. 7 can be applied to understand the design depicted in FIG. 12. Specifically, the light source structure 330 in FIG. 12 includes the first electrode structure 132, the second electrode structure 334, the light emitting unit 336, and the planarization layer 138. The first electrode structure 132 and the second electrode structure 334 are disposed on opposite sides of the planarization layer 138, and the planarization layer 138 laterally surrounds the light emitting unit 336. Meanwhile, FIG. 12 shows the intersection point C550 of the third signal line 556 of the peripheral circuit 550 and the first electrode circuit 334A of the second electrode structure 334.

As shown in FIG. 12, the planarization layer 138 can have a recess C138 at the intersection point C550, and the first electrode circuit 334A of the second electrode structure 334 can extend along the contour of the recess C138. An additional isolation material 558 can be disposed at the intersection point C550 and cover the first electrode circuit 334A in the recess C138. The third signal line 556 of the peripheral circuit 550 is then disposed on the isolation material 558. As such, the isolation material 558 can isolate the third signal line 556 of the peripheral circuit 550 from the first electrode circuit 334A of the second electrode structure 334, maintaining the electrical independence of the third signal line 556 and the first electrode circuit 334A. The isolation material 558 can be the same as that of the planarization layer 138 or can be any other non-conductive material.

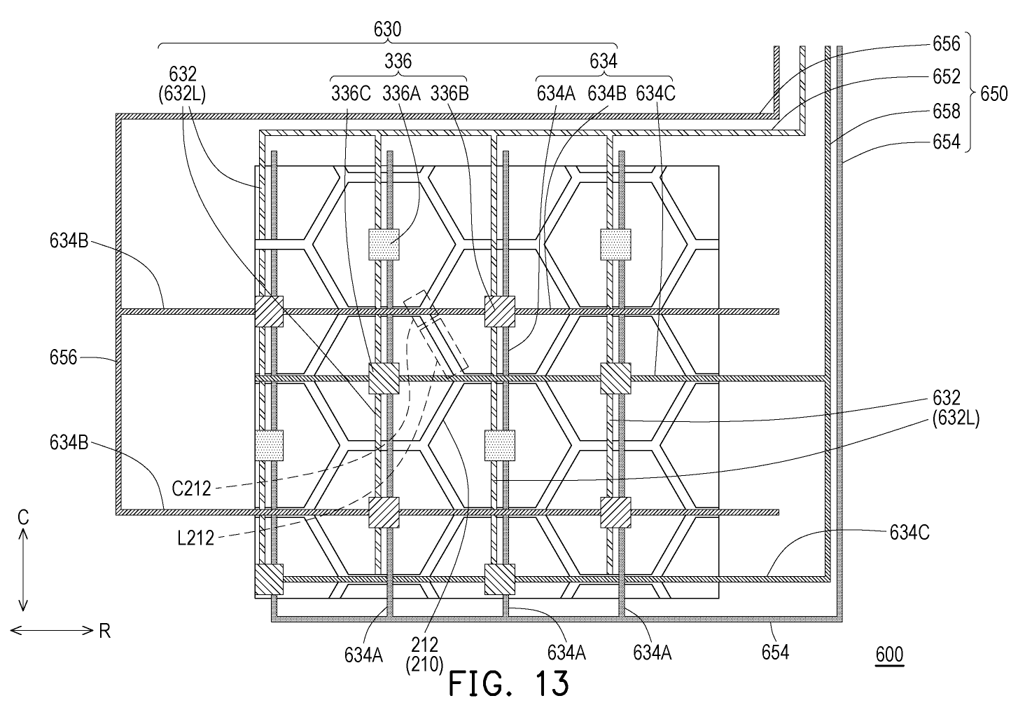

FIG. 13 is a schematic view showing an arrangement relationship between a light source structure and an isolation component in an electronic ink layer in a top view direction according to an embodiment of the disclosure. FIG. 13 shows that an electronic ink layer 600 includes package structures 210, light source structures 630, and peripheral circuits 650. For ease of explanation, FIG. 13 mainly shows the isolation components 212 of the package structures 210, the first electrode structures 632, the second electrode structures 634, and the light emitting units 336 of the light source structures 630, while other components are omitted. In addition to the above-mentioned components, the electronic ink layer 600 can further include the electronic ink material 120, the light shielding pattern 140, the first package layer 114, and the second package layer 116 of the package structure 210 as shown in FIG. 2.

In this embodiment, the layout design of the isolation components 212 is the same as those provided in the embodiment as shown FIG. 3, and the isolation components 212 can define the display units 202, each of which is filled with the electronic ink material 120 shown in FIG. 2. In the top view, the isolation components 212 can include the linear sections L212 extending in different directions, and these linear sections L212 can intersect at the intersection points C212. In this embodiment, the display units 202 are defined by the linear sections L212 enclosing hexagonal areas, which should however not be construed as a limitation in the disclosure. In other embodiments, the linear sections L212 can enclose areas of different geometric shapes to define the display units 202.

The light emitting units 336 include first light emitting units 336A, second light emitting units 336B, and third light emitting units 336C. The first light emitting units 336A, the second light emitting units 336B, and the third light emitting units 336C are each disposed within the display area of the display units 202. Here, one of the first light emitting units 336A, one of the second light emitting units 336B, and one of the third light emitting units 336C are respectively disposed in three display units 202 adjacent to one of the intersection points C212. Several first light emitting units 336A are each arranged in a row along the row direction R, several second light emitting units 336B are each arranged in a row along the row direction R, and several third light emitting units 336C are each arranged in a row along the row direction R. Moreover, the first light emitting units 336A, the second light emitting units 336B, and the third light emitting units 336C are located in different rows. Specifically, in this embodiment, the arrangement of the first light emitting units 336A, the second light emitting units 336B, and the third light emitting units 336C can be the same as that provided in the embodiment as shown in FIG. 11.

The first electrode structures 632 include a plurality of electrode circuits 632L, and each electrode circuit 632L can extend along the column direction C, cross over the display units 202, and contact the light emitting units 336. Each electrode circuit 632L can simultaneously contact at least one first light emitting unit 336A, at least one second light emitting unit 336B, and at least one third light emitting unit 336C. All of the electrode circuits 632L can be connected to one of the signal lines of the peripheral circuit 650, such as a common signal line 652.

The second electrode structures 634 include first electrode circuits 634A, second electrode circuits 634B, and third electrode circuits 634C. The first electrode circuits 634A each extend along the column direction C, while the second electrode circuits 634B and the third electrode circuits 634C each extend along the row direction R. The first electrode circuits 634A, the second electrode circuits 634B, and the third electrode circuits 634C all cross over the display units 202. Each of the first electrode circuits 634A can be parallel to the electrode circuits 632L of the first electrode structures 632, and each of the first electrode circuits 634A contacts and is electrically connected to the first light emitting units 336A in the same column. The second electrode circuits 634B intersect with the electrode circuits 632L of the first electrode structures 632, and each of the second electrode circuits 634B contacts and is electrically connected to the second light emitting units 336B in the same row. The third electrode circuits 634C intersect with the electrode circuits 632L of the first electrode structures 632, and each of the third electrode circuits 634C contacts and is electrically connected to the third light emitting units 336C in the same row.

The peripheral circuits 650 further include first signal lines 654, second signal lines 656, and third signal lines 658. All of the first electrode circuits 634A can be connected to the first signal lines 654, all of the second electrode circuits 634B can be connected to the second signal lines 656, and all of the third electrode circuits 634C can be connected to the third signal lines 658. As such, the first electrode circuits 634A, the second electrode circuits 634B, and the third electrode circuits 634C can serve to transmit different signals.

In this embodiment, the first electrode circuits 634A are parallel to the electrode circuits 632L of the first electrode structures 632. The first electrode circuits 634A and the electrode circuits 632L can extend towards opposite sides in the column direction C to be correspondingly connected to the first signal lines 654 and the common signal line 652. In other words, at least one portion of the first signal lines 654 and at least one portion of the common signal line 652 can be located on opposite sides of the electronic ink layer 600 in the column direction C. The second electrode circuits 634B and the third electrode circuits 634C both extend along the row direction R and are parallel to each other. The second electrode circuits 634B and the third electrode circuits 634C can extend towards opposite sides in the row direction R to be correspondingly connected to the second signal lines 656 and the third signal lines 658. In other words, at least one portion of the second signal lines 656 and at least one portion of the third signal lines 658 can be located on opposite sides of the electronic ink layer 600 in the row direction R.

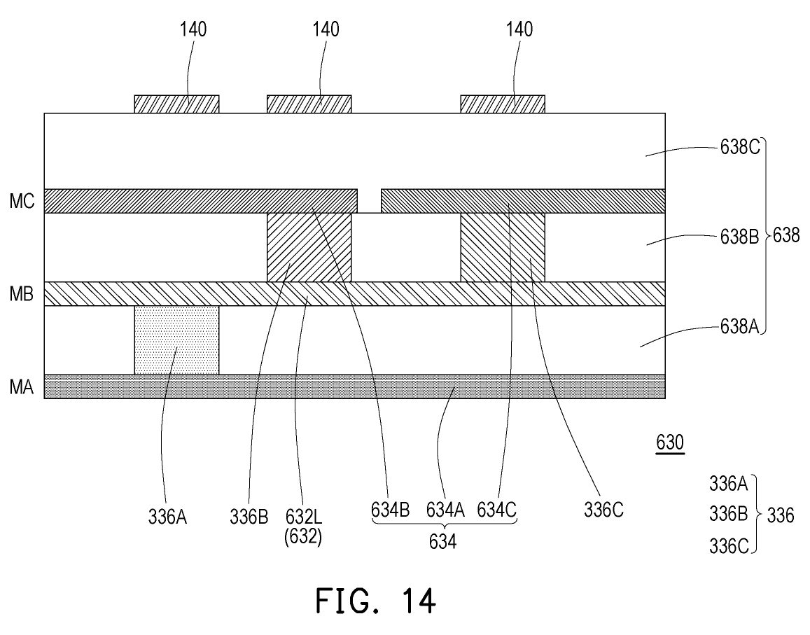

FIG. 14 is a schematic partial cross-sectional view of a light source structure in an electronic ink layer according to an embodiment of the disclosure. The cross-sectional structure in FIG. 14 can be deemed as an embodiment of the cross-sectional structure of the light source structure 630 sectioned along one of the electrode circuits 632L in the electronic ink layer 600 as depicted in FIG. 13, which should however not be construed as a limitation in the disclosure. The light source structure 630 includes a first electrode structure 632, a second electrode structure 634, a plurality of light emitting units 336, and a plurality of planarization layers 638. Additionally, FIG. 14 also shows the light shielding patterns 140, which are respectively located above the light emitting units 336. The layout configuration of the first electrode structure 632, the second electrode structure 634, and the light emitting units 336 in the top view direction can be referred to as that described above with reference to FIG. 13. In this embodiment, the first electrode structure 632 and the second electrode structure 634 can be implemented in the form of three conductive tiers MA, MB, and MC, and the planarization layers 638 can include a first planarization layer 638A, a second planarization layer 638B, and a third planarization layer 638C to isolate the conductive tiers MA, MB, and MC from one another. The first planarization layer 638A is disposed between the conductive tier MA and the conductive tier MB, the second planarization layer 638B is disposed between the conductive tier MB and the conductive tier MC, and the third planarization layer 638C covers the conductive tier MC and is located between the conductive tier MC and the light shielding patterns 140.

In this embodiment, the first electrode circuit 634A of the second electrode structure 634 is located in the conductive tier MA. When the light source structure 630 is applied to the package structure 210 shown in FIG. 2, the first electrode circuit 634A can be directly formed on the surface of the first package layer 114 through printing, coating, and so on. In other words, an adhesive layer may not exist between the first electrode circuit 634A and the first package layer 114. The first light emitting unit 336A in the light emitting units 336 is disposed on and in contact with the first electrode circuit 634A. The first planarization layer 638A is also disposed on the first electrode circuit 634A to laterally surround the first electrode circuit 634A, and a top surface of the first planarization layer 638A is substantially aligned with a top surface of the first light emitting unit 336A.

The first electrode structure 632 can include an electrode circuit 632L. The electrode circuit 632L is located in the conductive tier MB and disposed on the top surface of the first planarization layer 638A and the top surface of the first light emitting unit 336A. The electrode circuit 632L can contact the first light emitting unit 336A. As such, the electrode circuit 632L and the first electrode circuit 634A contact opposite sides of the first light emitting unit 336A to provide the driving current to the first light emitting unit 336A.

The second light emitting unit 336B and the third light emitting unit 336C in the light emitting units 336 are both disposed on and in contact with the electrode circuit 632L of the first electrode structure 632. The second planarization layer 638B is also disposed on the electrode circuit 632L of the first electrode structure 632. The second planarization layer 638B laterally surrounds the second light emitting unit 336B and the third light emitting unit 336C, and a top surface of the second planarization layer 638B, a top surface of the second light emitting unit 336B, and a top surface of the third light emitting unit 336C are substantially aligned.

The second electrode circuit 634B and the third electrode circuit 634C of the second electrode structure 634 are both located in the conductive tier MC, and the conductive tier MC is disposed on the second planarization layer 638B, the second light emitting unit 336B, and the third light emitting unit 336C. The second electrode circuit 634B and the third electrode circuit 634C can be conductive circuits that are not connected to each other.in the conductive tier MC. The second electrode circuit 634B and the electrode circuit 632L can contact the opposite surfaces of the second light emitting unit 336B to provide the driving current to the second light emitting unit 336B. The third electrode circuit 634C and the electrode circuit 632L can contact the opposite surfaces of the third light emitting unit 336C to provide the driving current to the third light emitting unit 336C.

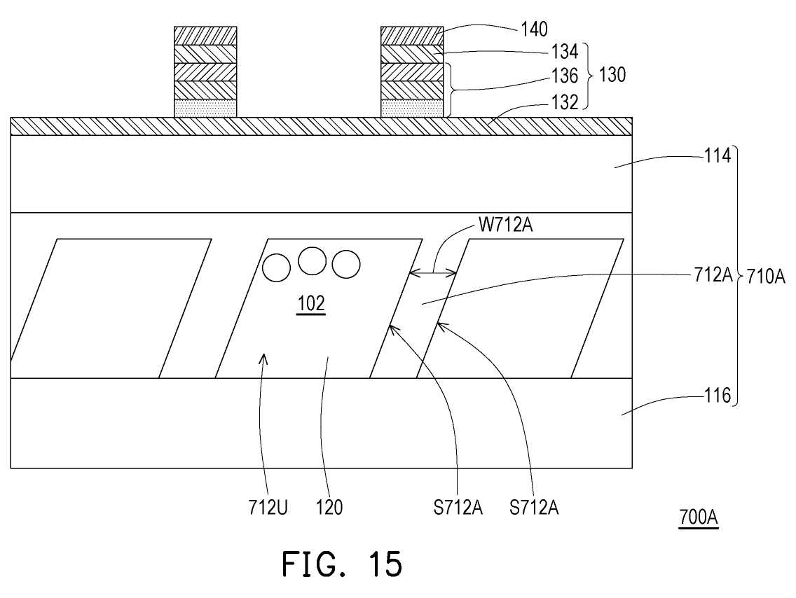

FIG. 15 is a schematic partial cross-sectional view of an electronic ink layer according to an embodiment of the disclosure. In FIG. 15, an electronic ink layer 700A includes a package structure 710A, an electronic ink material 120, light source structures 130, and light shielding patterns 140, where the electronic ink material 120, the light source structures 130, and the light shielding patterns 140 can be referred to as those described above with reference to FIG. 2. Each light source structure 130 can include a first electrode structure 132, a second electrode structure 134, and light emitting units 136. The package structure 710A includes an isolation component 712A, a first package layer 114, and a second package layer 116. The first package layer 114 covers the isolation component 712A. The isolation component 712A defines a plurality of encapsulation spaces 712U, and the electronic ink material 120 fills the encapsulation spaces 712U to form the display units 102. The isolation component 712A extends between the first package layer 114 and the second package layer 116 and has tilted sidewalls S712A. The isolation component 712A can have a fixed width W712A and a substantially parallelogram-shaped cross-sectional structure. Therefore, the tilted sidewalls S712A are tilted relative to the first package layer 114 and parallel to each other.

The light emitting units 136 are located above the isolation component 712A. Light from the light emitting units 136 can directly irradiate towards the display units 102 and can also irradiate the interface between the isolation component 712A and the electronic ink material 120, i.e., the tilted sidewalls S712A. Light emitted downward from the light emitting units 136 to the tilted sidewalls S712A can be refracted and guided to the display units 102, which contributes to improvement of light utilization efficiency.

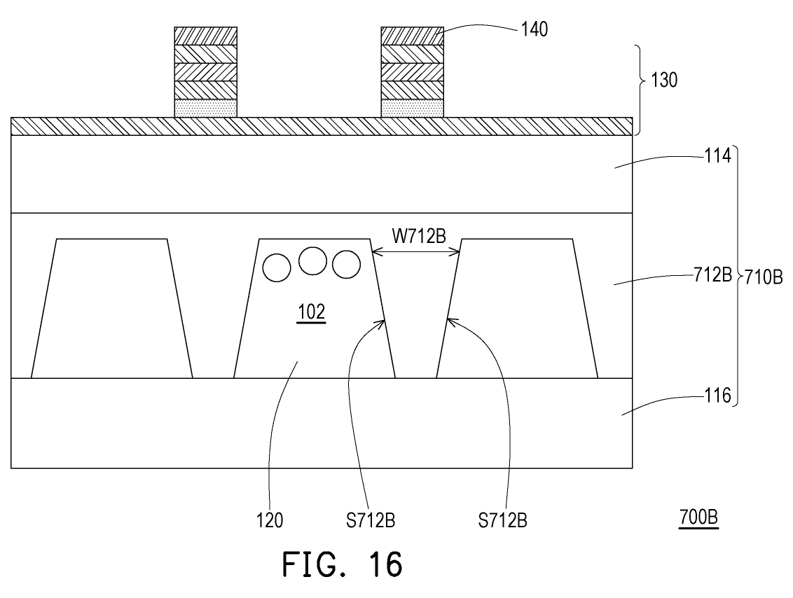

FIG. 16 is a schematic partial cross-sectional view of an electronic ink layer according to an embodiment of the disclosure. In FIG. 16, an electronic ink layer 700B includes a package structure 710B, an electronic ink material 120, a light source structure 130, and light shielding patterns 140, and the electronic ink layer 700B differs from the electronic ink layer 700A mainly in the design of the package structure 710B. Therefore, in the two embodiments, components marked by the same reference numbers correspond to each other across the two embodiments. The package structure 710B includes an isolation component 712B, a first package layer 114, and a second package layer 116. A width W712B of the isolation component 712B gradually decreases from the first package layer 114 towards the second package layer 116. The isolation component 712B has tilted sidewalls S712B, and the tilted sidewalls S712B are tilted relative to the first package layer 114. However, the tilted sidewalls S712B on both sides of the isolation component 712B are tilted in different directions. As such, the light emitted from the light emitting units 136 downward to the tilted sidewalls S712B can then be can be refracted towards the display units 102, and the light can be utilized by the display units 102.

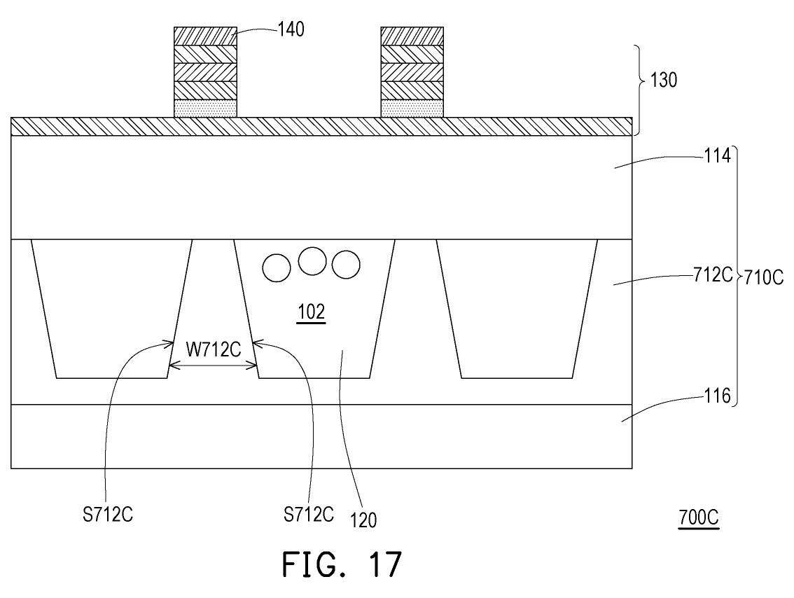

FIG. 17 is a schematic partial cross-sectional view of an electronic ink layer according to an embodiment of the disclosure. In FIG. 17, an electronic ink layer 700C includes a package structure 710C, an electronic ink material 120, a light source structure 130, and light shielding patterns 140, and the electronic ink layer 700C differs from the electronic ink layer 700B mainly in the design of the package structure 710C. Therefore, in the two embodiments, components marked by the same reference numbers correspond to each other across the two embodiments. The package structure 710C includes an isolation component 712C, a first package layer 114, and a second package layer 116. A width W712C of the isolation component 712C gradually increases from the first package layer 114 towards the second package layer 116. The isolation component 712C has tilted sidewalls S712C, and the tilted sidewalls S712C are all tilted relative to the first package layer 114. However, the tilted sidewalls S712C on both sides of the isolation component 712C are tilted in different directions. As such, the light emitted from the light emitting units 136 downward to the tilted sidewalls S712C can then be refracted towards the display units 102, and the light can be utilized by the display units 102.

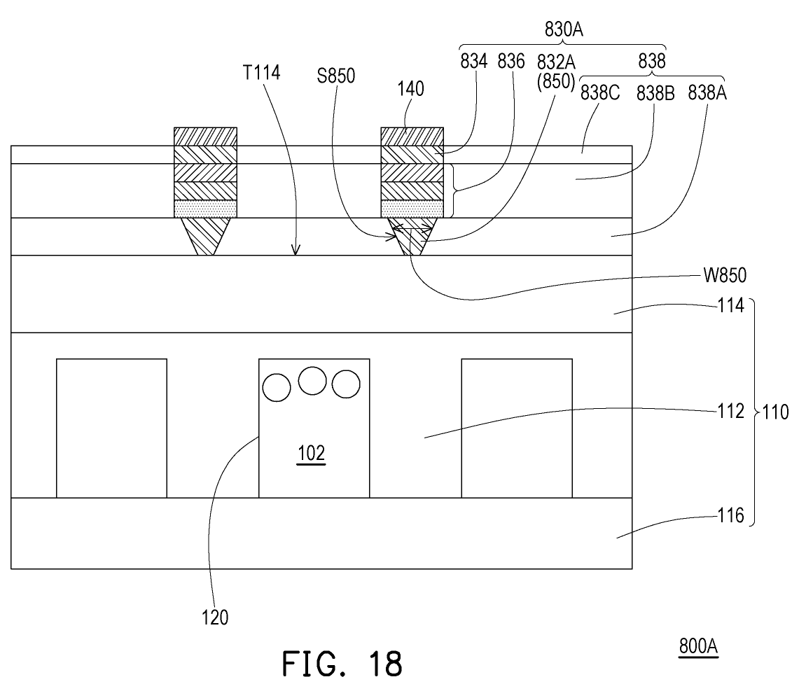

FIG. 18 is a schematic partial cross-sectional view of an electronic ink layer according to an embodiment of the disclosure. In FIG. 18, an electronic ink layer 800A includes a package structure 110, an electronic ink material 120, light source structures 830A, and light shielding patterns 140, where the package structure 110, the electronic ink material 120, and the light shielding patterns 140 can be referred to as those described above with reference to FIG. 2. The package structure 110 includes an isolation component 112, a first package layer 114, and a second package layer 116, so as to encapsulate the electronic ink material 120 into the display units 102. Each light source structure 830A includes a first electrode structure 832A, a second electrode structure 834, light emitting units 836, and a planarization layer 838. The planarization layer 838 can include a first planarization layer 838A, a second planarization layer 838B, and a third planarization layer 838C. The light shielding patterns 140 are disposed on the third planarization layer 838C and located above the light emitting units 836.

The first electrode structure 832A is directly disposed on the top surface T114 of the first package layer 114. The first planarization layer 838A laterally surrounds the first electrode structure 832A, and a top surface of the first planarization layer 838A is substantially aligned with a top surface of the first electrode structure 832A. The light emitting units 836 are disposed on the first electrode structure 832A. The second planarization layer 838B laterally surrounds the light emitting units 836, and a top surface of the second planarization layer 838B is substantially aligned with top surfaces of the light emitting units 836. The third planarization layer 838C laterally surrounds the second electrode structure 834, and the third planarization layer 838C can be thicker than the second electrode structure 834, which should however not be construed as a limitation in the disclosure. The light emitting units 836 can be implemented in the form of the light emitting units 136 in FIG. 2, the light emitting units 336 in FIG. 7, or any other equivalent alternative manner. In other words, individual light emitting units 836 can be white light emitting units with a plurality of stacked light emitting layers, white light emitting units composed of light emitting layers combined with light conversion materials, or light emitting units that emit light of one single color.

In this embodiment, the first electrode structure 832A can be considered as a light guiding portion 850 with a light guiding function. Moreover, a width W850 of the light guiding portion 850 tends to increase as the distance from the first package layer 114 increases, causing sidewalls S850 of the light guiding portion 850 to be tilted relative to the first package layer 114. Therefore, the light emitted by the light emitting units 836 can be refracted by the sidewalls S850 and directed towards the display units 102.

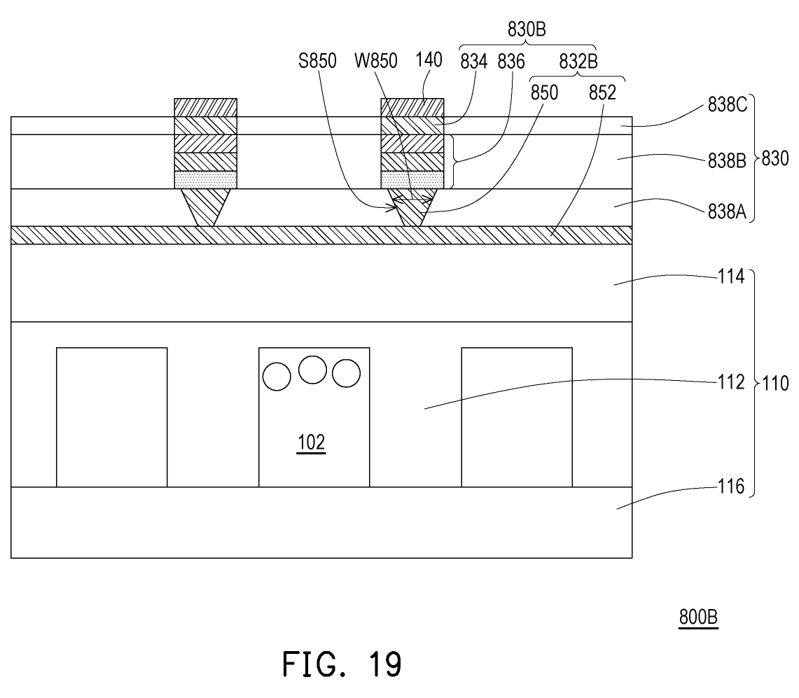

FIG. 19 is a schematic partial cross-sectional view of an electronic ink layer according to an embodiment of the disclosure. In FIG. 19, an electronic ink layer 800B includes a package structure 110, an electronic ink material 120, light source structures 830B, and light shielding patterns 140, where the package structure 110, the electronic ink material 120, and the light shielding patterns 140 can be referred to as those described above with reference to FIG. 2. The package structure 110 includes an isolation component 112, a first package layer 114, and a second package layer 116, so as to encapsulate the electronic ink material 120 into the display units 102. Each light source structure 830B includes a first electrode structure 832B, a second electrode structure 834, light emitting units 836, and a planarization layer 838. The planarization layer 838 can include a first planarization layer 838A, a second planarization layer 838B, and a third planarization layer 838C. The light shielding patterns 140 are disposed on the third planarization layer 838C and located above the light emitting units 836. Specifically, the difference between the electronic ink layer 800B and the electronic ink layer 800A mainly lies in the first electrode structures 832B of the light source structures 830B, and the remaining components of the electronic ink layer 800B can be referred to as those described above with reference to FIG. 18.

Each first electrode structure 832B includes a light guiding portion 850 and a layered portion 852, where the layered portion 852 is continuously extended and disposed on the first package layer 114, and the light guiding portion 850 is disposed between the layered portion 852 and the light emitting units 836. A width W850 of the light guiding portion 850 gradually decreases from the light emitting units 836 towards the layered portion 852, causing the sidewalls S850 of the light guiding portion 850 to be tilted relative to the first package layer 114. Therefore, similar to the first electrode structure 832A capable of performing the light guiding function in FIG. 18, the light guiding portion 850 aids in refracting the light emitted by the light emitting units 836 to travel towards the display units 102, whereby the light utilization efficiency of the electronic ink layer 800B is improved.

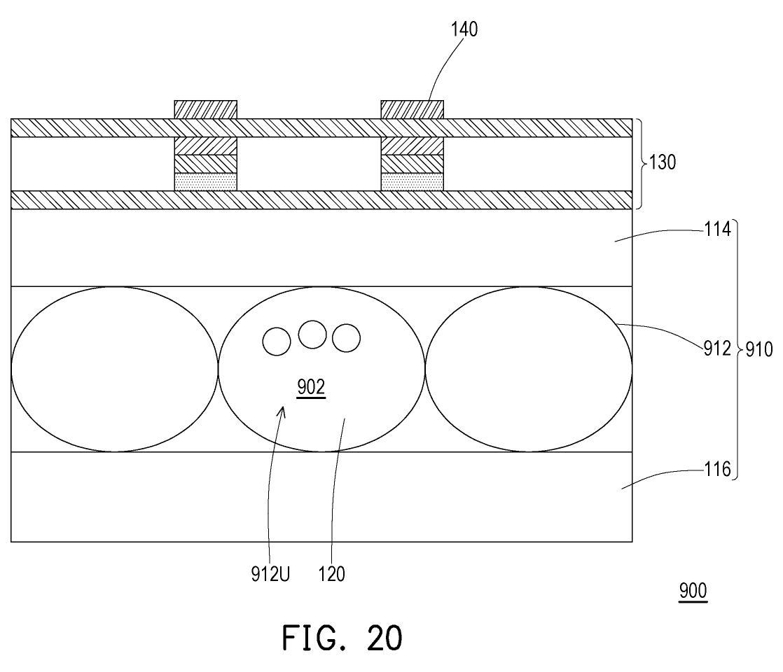

FIG. 20 is a schematic partial cross-sectional view of an electronic ink layer according to an embodiment of the disclosure. An electronic ink layer 900 includes a package structure 910, an electronic ink material 120, a light source structure 130, and light shielding patterns 140. The package structure 910 includes an isolation component 912, a first package layer 114, and a second package layer 116. The first package layer 114 covers the isolation component 112. The isolation component 912 defines a plurality of encapsulation spaces 912U, and the electronic ink material 120 fills the encapsulation spaces 912U to form a plurality of display units 902. The second package layer 116 and the first package layer 114 are located on opposite sides of the isolation component 912 to seal the display units 902 therebetween. The light source structure 130 is disposed on the first package layer 114. The light shielding patterns 140 are disposed on a side of the light source structure 130 away from the display units 102. Here, the isolation component 912 can have a microcapsule structure, and individual display units 902 can be constituted by the electronic ink material 120 in the individual encapsulation spaces 912U surrounded by the microcapsule structure. In addition, the design of the first package layer 114, the second package layer 116, the electronic ink material 120, the light source structure 130, and the light shielding patterns 140 can be referred to as the design provided in the embodiment depicted in FIG. 2, where the light source structure 130, in addition to the design depicted in in FIG. 2, can be implemented in the form of any one of the light source structures 230, 330, 430, 530, 630, 830A, and 830B mentioned in the previous embodiments.

To sum up, in the display device provided in one or more embodiments of the disclosure, the electronic ink layer has a built-in light source structure, which can actively emit light. At the same time, the light source structure need not be disposed on the electronic ink layer through attachment, which is conducive to streamlining the overall device volume.

It will be apparent to those skilled in the art that various modifications and variations may be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A display device, comprising:
a driving substrate; and
an electronic ink layer, disposed on the driving substrate and comprising a package structure, an electronic ink material, a light source structure, and a plurality of light shielding patterns, wherein the package structure comprises an isolation component and a first package layer covering the isolation component, the isolation component surrounds a plurality of encapsulation spaces, the electronic ink material fills the encapsulation spaces to form a plurality of display units, and the light source structure is disposed on the first package layer and comprises:
a first electrode structure;
a second electrode structure; and
a plurality of light emitting units, disposed between the first electrode structure and the second electrode structure and located between the first package layer and the light shielding patterns.

2. The display device according to claim 1, wherein the light emitting units are located above the isolation component.

3. The display device according to claim 1, wherein the light emitting units are respectively located above the display units.

4. The display device according to claim 1, wherein at least one of the first electrode structure and the second electrode structure continuously extends between the light emitting units and contacts the light emitting units.

5. The display device according to claim 1, wherein each of the light emitting units comprises a first color emitting layer, a second color emitting layer, and a third color emitting layer stacked together.

6. The display device according to claim 1, wherein the second electrode structure comprises a plurality of electrode circuits, and the electrode circuits contact different ones of the light emitting units.

7. The display device according to claim 6, wherein the electrode circuits are respectively disposed along the isolation component.

8. The display device according to claim 6, wherein the electrode circuits cross over above the display units.

9. The display device according to claim 1, wherein the light emitting units comprise a first light emitting unit, a second light emitting unit, and a third light emitting unit, and the first light emitting unit, the second light emitting unit, and the third light emitting unit are dispersedly disposed.

10. The display device according to claim 9, wherein the second electrode structure comprises a first electrode circuit, a second electrode circuit, and a third electrode circuit, the first electrode circuit contacts the first light emitting unit, the second electrode contacts the second light emitting unit, and the third electrode contacts the third light emitting unit.

11. The display device according to claim 10, wherein the first electrode circuit, the second electrode circuit, and the third electrode circuit are located at at least two conductive tiers.

12. The display device according to claim 11, wherein the first electrode structure is located at another conductive tier, and the another conductive tier is located between the at least two conductive tiers.

13. The display device according to claim 11, further comprising a planarization layer disposed respectively between the at least two conductive tiers.

14. The display device according to claim 1, wherein the light shielding patterns contact the second electrode structure.

15. The display device according to claim 1, wherein the isolation component has a tilted sidewall, and the tilted sidewall is tilted relative to the first package layer.

16. The display device according to claim 1, wherein a sidewall of the first electrode structure is tilted relative to the first package layer.

17. The display device according to claim 16, further comprising a planarization layer disposed on the first package layer and laterally surrounding the first electrode structure.

18. The display device according to claim 1, wherein the first electrode structure comprises a layered portion and a light guiding portion, the light guiding portion is disposed between the layered portion and the light emitting units, and a sidewall of the light guiding portion is tilted relative to the first package layer.

19. The display device according to claim 1, wherein the isolation component comprises a microcup structure or a microcapsule structure.

20. The display device according to claim 1, wherein a material of the first electrode structure and the second electrode structure comprises a transparent conductive material.
